(19) United States
(12) Patent Application Publication
(10) Pub. No.: US 2006/0187892 A1
(43) Pub. Date: Aug. 24, 2006

(54) Interactive method for determining network selection information for a user terminal in a wireless local area network

(76) Inventor: Wenlin Zhang, Guangdong (CN)

Correspondence Address: SUMMA, ALLAN & ADDITON, P.A., 11610 NORTH COMMUNITY HOUSE ROAD, SUITE 200, CHARLOTTE, NC, 28277, US

(21) Appl. No.: 11/348,922

(22) Filed: Feb. 6, 2006

Related U.S. Application Data
(63) Continuation-in-part of application No. PCT/CN04/00902, filed on Aug. 5, 2004.

(30) Foreign Application Priority Data
Aug. 7, 2003 (CN) 03153209.8

(51) Int. Cl. H04Q 7/24

(52) U.S. Cl. 370/338; 455/436

(57) ABSTRACT

The present invention discloses an interactive method for determining network selection information of user terminal in wireless local area network (WLAN). In the present invention, a user terminal covered by more than one WLAN inquires each detected WLAN successively in turn using preset initial network selection information. If the current WLAN access network is directly connected with the initially selected network of the user terminal, the initially selected network of the user terminal is determined to be the network to be accessed. If the current WLAN access network is not directly connected with the initially selected network of the user terminal, the next WLAN is inquired, and so on, until a WLAN access network directly connected with the initially selected network of the user terminal is found. If all the WLAN access networks have been inquired and there is no WLAN access network that is directly connected with the initially selected network of the user terminal, the process ends, or the user terminal can select an appropriate network to access from among all of the visited networks. The invention can allow a user terminal covered by more than one WLAN to select an appropriate wireless communication network to access.

### CROSS-REFERENCE TO RELATED APPLICATIONS

This application is a continuation-in-part of PCT Application No. PCT/CN2004/000902, filed Aug. 5, 2004, pending, which designates the U.S., which is hereby incorporated herein by reference in its entirety, and which claims priority from Chinese Application No. 03153209.8, filed Aug. 7, 2003.

### FIELD OF THE INVENTION

The present invention relates to network accessing techniques, and more particularly, to an interactive method for determining network selection information for a user terminal in a wireless local area network (WLAN).

### BACKGROUND OF THE INVENTION

Users are demanding increasingly high rate of wireless access. WLAN can provide high-rate wireless data access in a relatively small area. The majority of WLANs use the technical standard IEEE 802.11b. This standard utilizes a 2.4 GHz frequency band with a data transmission rate up to 11 Mbps. Other technical standards using the same frequency band include IEEE 802.11g and the Bluetooth, wherein the data transmission rate of IEEE 802.11g is up to 54 Mbps. Other new standards include IEEE 802.11a and ETSI BRAN Hiperlan2, which use a 5 GHz frequency band with the transmission rate up to 54 Mbps.

Although there are various standards for wireless access, most WLANs are used to transfer IP data packets. The specific WLAN access standard adopted by a wireless IP network is usually transparent to the upper-level IP. Such a network is typically configured with Access Points (AP) for implementing wireless access for a WLAN user terminal, like WLAN user equipment (UE), and with network controlling and connecting devices for implementing IP transmission.

With the rise and development of WLANs, research is focusing on the inter-workings of WLANs with various mobile communications networks, such as GSM, CDMA, WCDMA, TD-SCDMA, and CDMA2000. In accordance with the 3GPP standards, a user terminal can connect with the Internet and Intranets, as well as home networks and visited networks of a 3GPP system via a WLAN access network (WLAN AN). As an example, for local access, a WLAN user can connect to the 3GPP home network via a WLAN access network, as shown in FIG. 2. When roaming, a WLAN can connect to the 3GPP visited network via the WLAN access network. Some entities of the 3GPP visited network can be connected to corresponding entities of the 3GPP home network. For example, the 3GPP Authentication, Authorization, Accounting (AAA) proxy in the visited network can be connect to the 3GPP AAA server in the home network, and the WLAN Access Gateway (WAG) in the visited network can be connected to the Packet Data Gateway (PDG) in the home network, as shown in FIG. 1. FIG. 1 and FIG. 2 are schematic diagrams illustrating the networking architectures of a WLAN inter-working with a 3GPP system under roaming and non-roaming circumstances, respectively.

As shown in FIG. 1 and FIG. 2, a 3GPP system primarily includes a Home Subscriber Server (HSS)/ Home Location Register (HLR), 3GPP AAA server, 3GPP AAA proxy, a WAG, a PDG, a Charging Gateway (CGw)/Charging information Collecting Function (CCF), and an Online Charging System (OCS). The WLAN User terminal, WLAN access network, and all of the entities of the 3GPP system together constitute a 3GPP-WLAN inter-working network, which can be regarded as a WLAN service system. In this service system, 3GPP AAA server is in charge of authentication, authorization, and accounting of the WLAN user terminal, collecting the charging information sent from the WLAN access network and transferring the information to the charging system. The PDG is in charge of transmission of user data from the WLAN access network to the 3GPP network or other packet data networks. The charging system primarily receives and records the charging information of the WLAN user terminal transferred from the network while the OCS instructs the network to transmit online charging information periodically in accordance with the expenses of the online charged users, collects statistics and conducts control.

Under non-roaming circumstances, when a WLAN user terminal desires direct access to the Internet/Intranet, the WLAN user terminal can access the Internet/Intranet via a WLAN access network after it accomplishes an authentication step with the AAA server (AS) via the WLAN access network. If the WLAN user terminal wants to access the service of the 3GPP packet switched (PS) domain as well, it may further request the service of Scenario 3 from the 3GPP home network. That is, the WLAN user terminal can initiate a service authorization request for Scenario 3 to the AS of the 3GPP home network, which will conduct service authentication and authorization for that request. If the authentication and authorization succeeds, the AS will send an access accept message to the WLAN user terminal and assign a corresponding PDG for the WLAN user terminal. When a tunnel is established between the WLAN user terminal and the assigned PDQ the WLAN user terminal can access the service of the 3GPP PS domain. Meanwhile, the offline charging system and OCS records the charging information based on the WLAN user terminal's occupation of the network.

Under roaming conditions, when a WLAN user terminal desires direct access to the Internet/Intranet, it may request the 3GPP home network by way of the 3GPP visited network for access to the Internet/Intranet. If the WLAN user terminal also wants to request the service of Scenario 3 to access the service of the 3GPP PS domain, the WLAN user terminal needs to initiate via the 3GPP visited network a service authorization process at the 3GPP home network. The authorization is carried out likewise between the WLAN user terminal and AS of the 3GPP home network. After the authorization succeeds, the AS assigns the corresponding home PDG for the WLAN user terminal. In this case, the WLAN user terminal can access the service of the 3GPP PS domain of the home network after it establishes a tunnel with the assigned PDG via the WAG of the 3GPP visited network.

As shown in FIG. 3, in a 3GPP-WLAN inter-working network, if a WLAN is connected at the same time with a plurality of 3GPP visited networks, that is, a plurality of wireless communication networks (the term 3GPP visited networks as used herein refers to Visited Public Land Mobile Networks (VPLMN)) to which the WLAN AN can route the authentication signal, it can be necessary for a WLAN user terminal to select the desired VPLMN to access after the user terminal accesses the WLAN. For example, in China, a WLAN access network may be connected simultaneously with two operating VPLMN, China Mobile and China Unicom. In this case, a user of China Unicom, after getting access via the WLAN, has to instruct the WLAN access network to access the operating VPLMN of China Unicom.

As another example, a French user may roam to a WLAN in China. If the home network of the French user has roaming protocols with both China Mobile and China Unicom, when the WLAN access network is connected with both China Mobile and China Unicom, this French user needs to select a VPLMN to get access after accessing the WLAN.

Steps 401-408 of FIG. 4 of a published patent application illustrate the following proposed solution for selecting a network. When a WLAN user terminal accesses a 3GPP-WLAN inter-working network via the WLAN, in accordance with this patent application, when the WLAN user terminal requests the first access after having established a radio connection with the WLAN access network, authentication is conducted between the user terminal and the network and the network requests the user identity from the user terminal. Then the user terminal will send a response message containing network selection information to the WLAN access network. The WLAN access network decides based on this network selection information whether the selected network is one of the wireless communication networks connected with the WLAN, and, if so, the current user terminal will be connected to the selected network for authentication and subsequent processes. Otherwise, i.e., the selected network is not directly connected with the WLAN access network, then the network will issue an advisement message to the current user terminal, and the user terminal will perform subsequent processes in accordance with the advisement message. The network selection information includes information about the wireless communication network to which the user terminal currently desires access, and this information may be placed in a field independently configured or placed in the user identity field defined in the Network Access Identifier (NAI) format, which includes two portions, a username portion and a realm name portion.

However, if the current user terminal is covered by a plurality of WLAN networks simultaneously, the above solution cannot guarantee selection of the most appropriate or optimum PLMN to serve the user terminal. For example, it cannot guarantee that the home network of the user terminal will be selected. Taking the network architecture shown in FIG. 5 as an example, the WLAN user terminal is simultaneously covered by WLAN1 and WLAN2, wherein WLAN1 is connected with three visited networks of the current user terminal, VPLMN1, VPLMN2, and VPLMN3, while WLAN2 is connected with the home network, HPLMN, and the visited network, VPLMN3, of the current user terminal. In this case, the optimum selection for the current user terminal is the home network of this user terminal, HPLMN, but it is quite likely, based on the network selection solution in the prior art, that this user terminal will get access via WLAN1 while the networks directly connected with WLAN1 from which the user terminal can select are all roaming networks. As a result, the user terminal does not have an opportunity to select its home network directly connected with WLAN2. To date, there has not been a specific solution to allow a user terminal to select the most appropriate or optimum wireless communication network whenever it seeks access.

### SUMMARY OF THE INVENTION

The present invention provides an interactive method for determining network selection information for a user terminal in a WLAN so that a user terminal covered by more than one WLAN can select, based on its need, an appropriate wireless communication network to access.

The interactive method for determining network selection information for a user terminal in a WLAN in accordance with an exemplary embodiment of the present invention can include the following steps:

a. a user terminal covered by more than one WLAN selects one WLAN from a group of WLANs that are detected by the user terminal and sends initial network selection information including information about one or more wireless communication networks to the access network of the selected WLAN; and

b. decide whether the selected WLAN access network can route an authentication request to at least one wireless communication network indicated in the initial network selection information, and, if so, send an authentication request from the user terminal to at least one wireless communication network indicated in the initial network selection information, and end the current network selection procedure. Otherwise, the selected WLAN access network provides the user terminal information about wireless communication networks connected with the selected WLAN, the user terminal stores the received information and decides whether there is a remaining WLAN that has not been selected. If there is, the user terminal can return to step a; if there is not, the user terminal can end the current network selection procedure.

If there is not a WLAN that has not been selected, the method can further include the following steps:

c. the user terminal selects a wireless communication network desired to access based on stored information about wireless communication networks, and sends information about the selected wireless communication network as the network selection information to the WLAN access network corresponding to the selected wireless communication network.

The method can further include the step of presetting an initial network selection in the user terminal.

Step a can further include the following steps:

a1. after selecting a WLAN, the user terminal establishes a radio connection with the selected WLAN access network. The selected WLAN access network or the user terminal initiates an authentication procedure, and the WLAN access network sends a username request message to the user terminal; and

a2. upon receiving the username request message, the user terminal returns a response message containing the initial network selection information to the selected WLAN access network.

The initial network selection can be the home network of the user terminal.

The method can further include the following step after step c:

d. the WLAN access network that has received the network selection information of the user terminal sends the authentication request of the user terminal to the wireless communication network indicated in the network selection information.

In step c, the user terminal selects an optimum wireless communication network to access based on a preset criterion for determining the optimum visited network. The criterion for determining the optimum visited network can be determined by such factors as service charge rate, network bandwidth, network speed, network capacity, and the services that could be provided for the user terminal.

In step b, the selected WLAN access network can send to the user terminal information about all of the wireless communication networks directly connected with the WLAN access network. Alternatively, in step b, the selected WLAN access network can send to the user terminal information about all of the wireless communication networks that are directly connected with the WLAN access network and have roaming relations with the home network indicated in the network selection information.

The process of providing the user terminal information about the wireless communication networks in step b can be performed by a first hop AAA functionality associated with the user terminal. The first hop AAA functionality can be one of an access controller (AC), an access point (AP) and a local AAA server. The first hop AAA functionality can be located in one of a WLAN access network and a PLMN.

In accordance with the interactive method for determining network selection information for a user terminal in a WLAN, the user terminal covered by more than one WLAN can inquire each of the detected WLANs successively in turn with the preset initial network selection information and decide whether the user terminal can access the initially selected network via a WLAN, and, if not, the user terminal may select any of the wireless communication networks to access. In this way, the user terminal can select a relatively optimum wireless communication network to access when it is covered by a plurality of WLANs to improve services provided the user.

### BRIEF DESCRIPTION OF THE DRAWINGS

FIG. 1 is a schematic diagram illustrating the network architecture of an inter-working WLAN system and 3GPP system under roaming conditions;

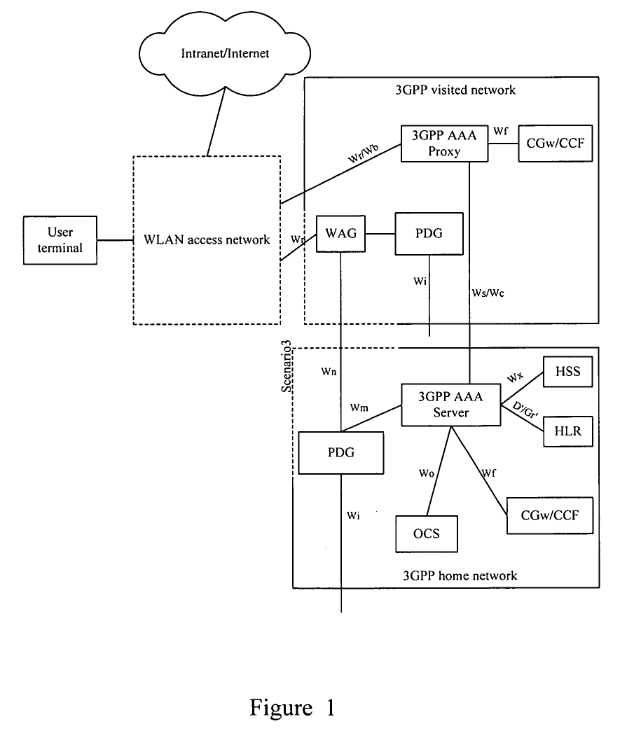

FIG. 2 is a schematic diagram illustrating the network architecture of an inter-working WLAN system and 3GPP system under non-roaming conditions;

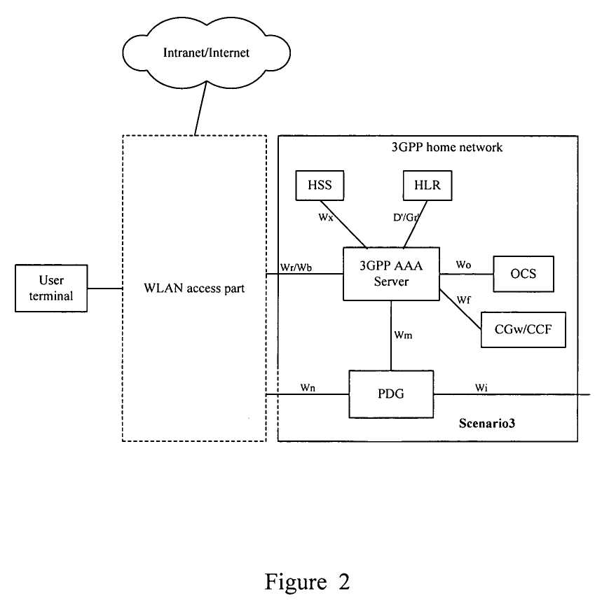

FIG. 3 is a schematic diagram illustrating the network architecture of a WLAN connecting with a plurality of visited networks;

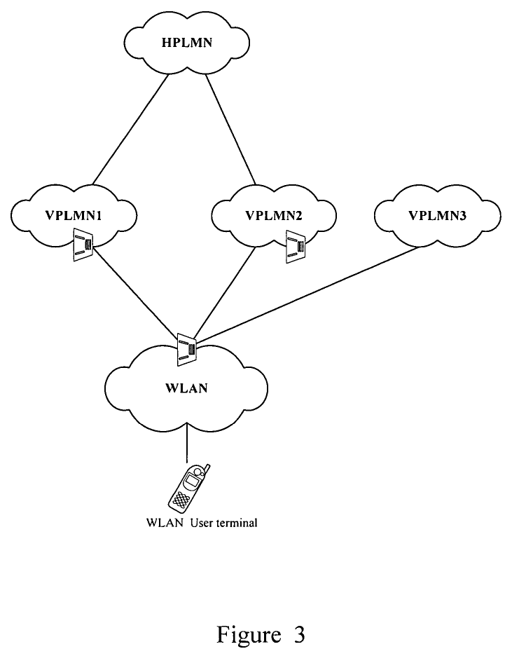

FIG. 4 is a flowchart illustrating interactive processing of the network selection information for a user terminal in accordance with an exemplary embodiment of the present invention;

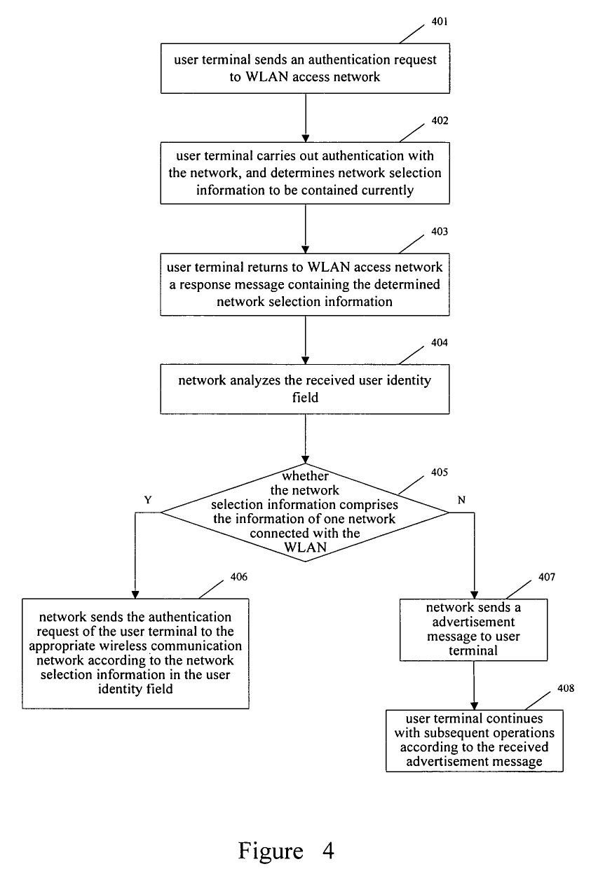

FIG. 5 is a schematic diagram illustrating the network architecture with the current user terminal covered by a plurality of WLANs;

FIG. 6 is a flowchart for implementing the method in accordance with an exemplary embodiment of the present invention;

FIG. 7 is a flowchart illustrating interactive processing for determining network selection information in accordance with a first exemplary embodiment of the present invention;

FIG. 8 is a flowchart illustrating interactive processing for determining network selection information in accordance with a second exemplary embodiment of the present invention; and

FIG. 9 is a flowchart illustrating interactive processing for determining network selection information in accordance with a third exemplary embodiment of the present invention.

### DETAILED DESCRIPTION OF THE INVENTION

The present invention now will be described more fully hereinafter in the following detailed description of the invention, in which some, but not all embodiments of the invention are described. Indeed, this invention may be embodied in many different forms and should not be construed as limited to the embodiments set forth herein; rather, these embodiments are provided so that this disclosure will satisfy applicable legal requirements.

The present invention can allow a user terminal covered by more than one WLAN to inquire each detected WLAN successively in turn using the initial network selection information. If the WLAN access network is directly connected with the initially selected network of the user terminal, the initially selected network of the user terminal is determined to be the network to be accessed. If the WLAN access network is not directly connected with the initially selected network of the user terminal, the networks directly connected with the next WLAN are inquired successively in turn, and so on, until a WLAN directly connected with the initially selected network of the user terminal is found. If networks connected with all the WLANs have been inquired and there is no WLAN access network that is directly connected with the initially selected network of the user terminal, an optimum visited network can be selected to provide access based on the information of wireless communication network issued by the access networks and the priority conditions set by the user, or information can be presented to the user so that the user can select a network to access.

As used herein, the term network selection information refers to information about one or more wireless communication networks that the user terminal currently desires to access and which are connected with WLANs. The network selection information may be placed in a separately-configured field in an authentication request or placed in a user identity field of an authentication request, and the user identity can be defined in the NAI format. The initially selected network of each user terminal can be preset and may be the home network of each user terminal.

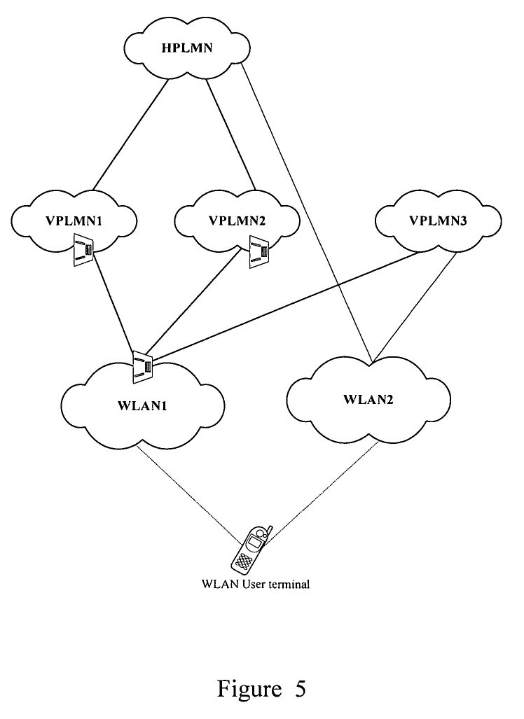

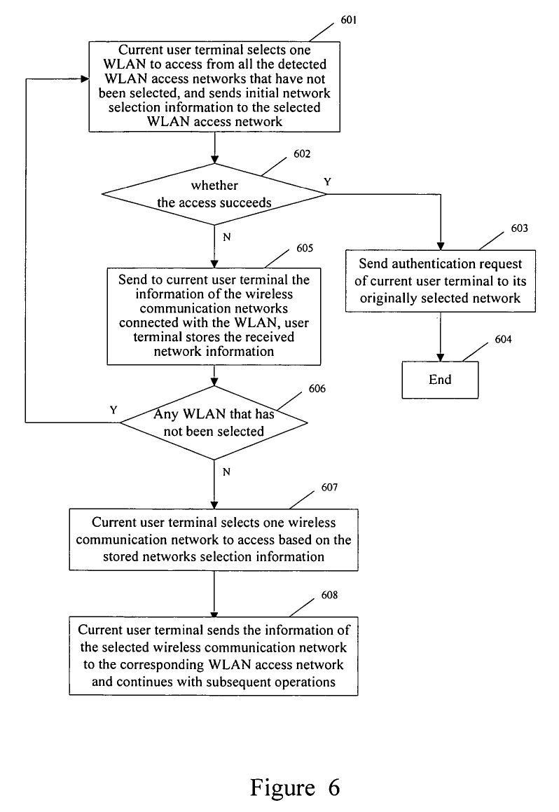

Based on the network architecture shown in FIG. 5, when a WLAN user terminal accesses a 3GPP-WLAN inter-working network via the WLAN, the user terminal initiates WLAN detection, detects more than one WLAN, and starts an interactive process for determining the network selection information in accordance with the present invention. As shown in FIG. 6, the interactive processing can include the steps of:

Step 601: The user terminal selects one of the WLANs that have been detected but not selected to access. The selection here may include a selection at will or a selection based on certain criterion, for example, signal intensity.

Then, an authentication procedure can be initiated by the WLAN user terminal or the WLAN. Using the authentication procedure initiated by WLAN user terminal as an example, the WLAN user terminal can first send an authentication request to the currently selected WLAN access network. After receiving the request, the WLAN access network starts an authentication procedure with the user terminal, and the user terminal uses the initial network selection information as the network selection information. Specifically, the WLAN access network sends a user identity request message to the user terminal, requesting the username of the user terminal. After receiving the request, the user terminal sends to the WLAN access network a response message containing the information of the initially selected network of the user terminal.

Steps 602˜605: After receiving the response message, the WLAN access network analyzes the user identity field of the response message and decides whether the network selection information contained in the user identity field indicates a wireless communication network connected with the WLAN. If so, i.e., WLAN1 is directly connected with the initially selected network of the user terminal and WLAN1 is able to route an authentication request to the selected network, the WLAN access network determines that the wireless communication network the user terminal desires to access is its initially selected network, sends the authentication request of the user terminal to its home network for authentication, and ends the current process. Otherwise, i.e., WLAN1 is not directly connected with the initially selected network of the user terminal, the network issues to the user terminal information about wireless communication networks connected with the currently selected WLAN. The user terminal saves all the network information issued, and the process proceeds to step 606.

Steps 606˜608: decide whether there is an WLAN that has not been selected to access, and, if there is, return to step 601, and likewise, the selection may be a selection at will or a selection based on a certain criterion. If there is not an WLAN that has not been selected to access, the user terminal selects one of the saved wireless communication networks to access, and sends to the WLAN access network corresponding to the selected wireless communication network the information of the selected wireless communication network as the network selection information to execute subsequent operations. Here, the user terminal may, based on the preset criterion for determining the optimum visited network, select the optimum wireless communication network to access. The criterion for determining the optimum visited network can be determined by such factors as the service charge rate, bandwidth, speed, and capacity of each wireless communication network as well as the services that could be provided for user terminal by the network. The skilled artisan will appreciate that the user terminal may display the available networks for the user, who can make the selection.

In the above process, steps 607 and 608 may be omitted, i.e., the current process can be ended if the initially selected network has not been successfully accessed after all of the detected WLAN have been inquired successively, and no further selection of wireless communication network will be made to obtain access.

In the above process, the information about the wireless communication networks provided by the WLAN for the user terminal to make a selection is saved in a special network information storing unit. Typically, such information includes such parameters as network name, QoS of network bearer capability, bandwidth, service capacity, WLAN inter-working scenarios that could be provided, charging rate, and types of service provider. When issuing the information about the wireless communication networks connected with the WLAN, the WLAN may issue the information about all of the wireless communication networks connected with the WLAN, or select information about the visited networks having roaming relations with the home network indicated by the user terminal to issue, or issue no information if there is no such visited network, or notify the user that no roaming relations exist. The procedure of issuing the information about all of the wireless communication networks may be performed by a first AAA functionality associated with the user terminal such as access controller (AC), access point (AP) or local Authentication Authorization Accounting (AAA) server. Typically, the first hop AAA functionality is located in a WLAN access network or a PLMN.

The present invention will be further exemplified by the following non-limiting examples.

### EMBODIMENT 1

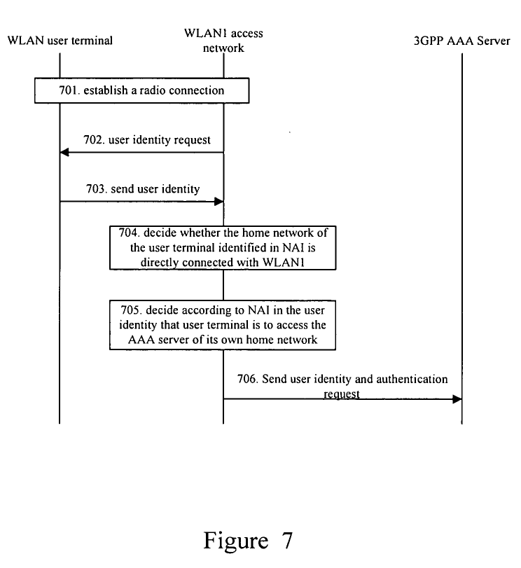

In the 3GPP-WLAN inter-working network of this embodiment, WLAN1 is directly connected with the home network of the user terminal, the user terminal inquires successively in turn the networks connected with WLAN1 using the information of its home network as the initial network selection information, and succeeds in accessing its home network via WLAN1. As shown in FIG. 7, the interactive processing for determining network selection information in this embodiment comprises the steps of:

Steps 701˜703: When accessing a 3GPP-WLAN inter-working network via WLAN1, the user terminal first establishes a connection with the WLAN1 access network. Then the WLAN1 access network sends to the user terminal a user identity request. After receiving this request, the WLAN user terminal sends to the WLAN1 access network a response message containing the information of the home network of the user terminal.

Steps 704˜706: After receiving the response, the WLAN1 access network finds that the home network of the user terminal identified in the message is a wireless communication network connected with the WLAN1, and then further determines an AAA server of the home network the user terminal desires to access. After that, the WLAN1 sends the user identity of the user terminal and an authentication request to the 3GPP AAA server of the home network of the user terminal for authentication.

### EMBODIMENT 2

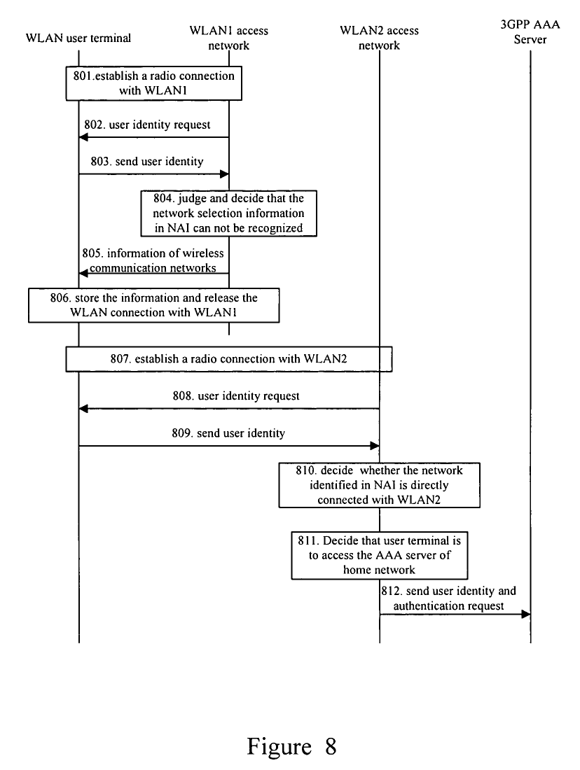

In the 3GPP-WLAN inter-working network of this embodiment, WLAN1 is not directly connected to the home network of the user terminal, and the WLAN2 is directly connected with the home network of the user terminal. The user terminal first inquires successively in turn of the networks connected with the WLAN1 using the information of its home network as the initial network selection information, but fails to get access. Then the user terminal inquires successively in turn the networks connected with the WLAN2 using the information of its home network as the initial network selection information as well, and succeeds in accessing its home network via WLAN2. As shown in FIG. 8, the interactive process for determining network selection information in this embodiment can include the steps of:

Steps 801˜803: The same as steps 701˜703 in Embodiment 1.

Steps 804˜806: After receiving the response, the WLAN1 decides whether the home network of the user terminal identified in the message is a wireless communication network connected with the WLAN1. If not, then the WLAN1 issues to the user terminal the information about the wireless communication networks connected with the WLAN1. After receiving this information, the user terminal saves the information and then disconnects the radio connection with the WLAN1.

Steps 807˜809: The user terminal sets up a radio connection with the WLAN2 access network, and the WLAN2 access network sends a user identity request to the user terminal. After receiving this request, the WLAN user terminal sends a response message containing the information about the home network of the user terminal.

Steps 810˜812: After receiving the response, the WLAN2 access network finds that the home network of the user terminal identified in the message is a wireless communication network connected with the WLAN2, and then further determines an AAA server of the home network the user terminal desires to access. The WLAN2 access network sends the user identity of the user terminal and an authentication request to the 3GPP AAA server of the home network of the user terminal for authentication.

### EMBODIMENT 3

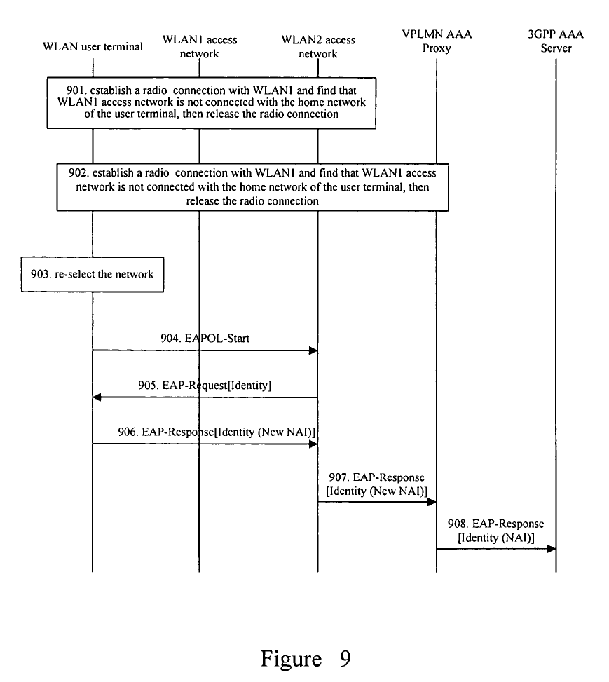

In the 3GPP-WLAN inter-working network of this embodiment, neither the WLAN1 nor the WLAN2 is directly connected with the home network of the user terminal. The user terminal first inquires successively in turn the networks connected with the WLAN1 using the information from its home network as the initial network selection information, but fails to get access. Then the user terminal inquires successively in turn the networks connected with the WLAN2 using the information of its home network as the initial network selection information as well, but fails again to get access. Finally, the user terminal selects an optimum wireless communication network from all of those that are connected with the WLAN1 and the WLAN2 to access. As shown in FIG. 9, the interactive process for determining network selection information in this embodiment can include the steps of:

Step 901: Set up a radio connection with the WLAN1 access network, and send to the WLAN1 access network a response message containing the information of the home network of the user terminal. After receiving the response message, the WLAN1 finds that the home network of the user terminal is not connected with the WLAN1 access network, and then sends to the user terminal the information of the wireless communication networks connected with the WLAN1. The user terminal saves the information received, and then the WLAN1 removes the radio connection with the user terminal.

Step 902: Set up a radio connection with the WLAN2 access network, and send to the WLAN2 access network a response message containing the information of the home network of the user terminal. After receiving the response message, the WLAN2 finds that the home network of the user terminal is not connected with the WLAN2 access network, and then sends to the user terminal the information about the wireless communication networks connected with WLAN2. The user terminal saves the information received, and then WLAN2 removes the radio connection with the user terminal.

Steps 903˜904: The user terminal selects one wireless communication network connected with the WLAN2 access network from all of the wireless communication networks from which the information has been saved in the user terminal, and then actively initiates an authentication procedure again to the WLAN2 by means of the initial authentication message EAPOL-Start.

Steps 905˜906: After receiving the EAPOL-Start message, the WLAN2 access network issues the EAP-Request[Identity] message again to the user terminal, requesting the user identity The WLAN user terminal returns to the WLAN2 access network the user identity containing the new network selection information by means of the EAP-Response[Identity] message.

Step 907˜908: After receiving the new user identity, the WLAN2 access network determines, based on the new network selection information therein, the wireless communication network selected by the user terminal, and sends an authentication request from the user terminal to the AAA proxy and AS of the network identified by the network selection information for authentication.

The foregoing description is directed to exemplary embodiments of the present invention and should not be construed as limiting the protection scope of this invention. Many modifications and other embodiments of the invention will come to mind to one skilled in the art to which this invention pertains having the benefit of the teachings presented in the foregoing descriptions. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation, the scope of the invention being defined in the claims.

That which is claimed is:

1. An interactive method for determining network selection information for a user terminal in a wireless local area network (WLAN), comprising the steps of:
a) selecting by a user terminal covered by more than one WLAN at least one of the WLANs and sending initial network selection information including information about one or more wireless communication networks to a WLAN access network of the selected WLAN;
b) deciding whether the selected WLAN access network can route an authentication request to at least one wireless communication network of the initial network selection information, and, if yes, sending an authentication request to at least one wireless communication network of the initial network selection information and ending the network selection procedure; or, if no, advising the user terminal of information relating to wireless communication networks connected to the selected WLAN, storing by the user terminal the received information, deciding by the user terminal whether there is a remaining WLAN that has not been selected, and, if yes, returning to step a).

2. The method according to claim 1, wherein if there is no remaining WLAN that has not been selected, further comprising the step of:
c) selecting by the user terminal a wireless communication network desired to access based on the stored information about the wireless communication networks, and sending the information about the selected wireless communication network as the network selection information to the WLAN access network corresponding to the selected wireless communication network.

3. The method according to claim 1, further comprising the step of presetting an initial network selection in the user terminal.

4. The method according to claim 1, wherein step a) further comprises:
a1) after selecting a WLAN, establishing by the user terminal a radio connection with the selected WLAN access network; initiating by the selected WLAN access network or the user terminal an authentication process; and sending by the WLAN access network a username request message to the user terminal; and
a2) upon receiving the username request message, returning by the user terminal a response message containing the initial network selection information to the selected WLAN access network.

5. The method according to claim 1, wherein the initial network selected is the home network of the user terminal.

6. The method according to claim 3, wherein the initial network selected is the home network of the user terminal.

7. The method according to claim 4, wherein the initial network selected is the home network of the user terminal.

8. The method according to claim 2, further comprising after step c):
d) sending by the WLAN access network that has received the network selection information of the user terminal the authentication request of the user terminal to the wireless communication network indicated in the network selection information.

9. The method according to claim 2, wherein step c) further comprises selecting by the user terminal an optimum wireless communication network to access based on a preset criterion for determining the optimum visited network.

10. The method according to claim 9, wherein the criterion for determining the optimum visited network is determined by factors selected from the group consisting of service charge rates, network bandwidths, network speeds, network capacities, and services that can be provided for the user terminal.

11. The method according to claim 1, wherein step b) further comprises sending by the selected WLAN access network to the user terminal information about all wireless communication networks directly connected to the WLAN access network.

12. The method according to claim 1, wherein step b) further comprises sending by the selected WLAN access network to the user terminal information about all wireless communication networks directly connected to the WLAN access network and having roaming relations with the home network indicated in the network selection information.

13. The method according to claim 1, wherein the step of advising the user terminal of information relating to the wireless communication networks in step b) is performed by a first hop authentication authorization accounting (AAA) functionality associated with the user terminal.

14. The method according to claim 11, wherein the first hop AAA functionality is one of an access controller (AC), an access point (AP) and a local AAA server.

15. The method according to claim 11, wherein the first hop AAA functionality is located in one of a WLAN access network and a public land mobile network (PLMN).
